(19) United States
(12) Patent Application Publication
(10) Pub. No.: US 2025/0034730 A1
(43) Pub. Date: Jan. 30, 2025

(54) ELECTROCATALYSTS FOR THE OXYGEN EVOLUTION REACTION IN ACID CONDITIONS

(71) Applicant: Toyota Motor Engineering & Manufacturing North America, Inc., Plano, TX (US)

(72) Inventors: Siwen Wang, Ann Arbor, MI (US); Chen Ling, Troy, MI (US); Yui Wakabayashi, Ann Arbor, MI (US); Honghong Lin, Ann Arbor, MI (US); Li Q. Zhou, Okemos, MI (US); Charles Alexander Roberts, Farmington Hills, MI (US); Hongfei Jia, Ann Arbor, MI (US); Debasish Banerjee, Ann Arbor, MI (US)

(73) Assignee: Toyota Jidosha Kabushiki Kaisha, Toyota-shi Aichi-ken (JP)

(21) Appl. No.: 18/227,114

(22) Filed: Jul. 27, 2023

(51) Int. Cl. C25B 11/042; C01G 55/00

(52) U.S. Cl. CPC C25B 11/042; C01G 55/002; C01P 2002/50; C01P 2002/77; C01P 2006/40

(57) ABSTRACT

An electrocatalyst for the production of hydrogen from water includes a pyrochlore compound with a composition or chemical formula of RE₂(Ru)₂ₓM₂₋₂ₓO₇, RE₂(Ir)₂ₓM₂₋₂ₓO₇or RE₂(Ir,Ru)₂ₓM₂₋₂ₓO₇, where RE is a rare earth element, M is an alkali metal, alkaline carth metal, transition metal, post-transition metal, Ge, or Sb, and x is less than 1.0 and greater than 0.0.

### TECHNICAL FIELD

The present disclosure generally relates to electrocatalysts, and particularly to electrocatalysts for the oxygen evolution reaction.

### BACKGROUND

Catalysts for the acidic oxygen evolution reaction (OER) play key roles in enabling use of technologies such as proton exchange membrane water electrolysis (PEMWE) systems for the production of hydrogen. However, costs associated with precious metals used to produce effective catalysts have inhibited wide scale commercialization of PEMWE systems.

The present disclosure addresses these issues with catalysts for the acidic OER, and other issues related to catalysts.

### SUMMARY

In one form of the present disclosure, an electrocatalyst includes a pyrochlore compound with a composition or chemical formula of RE₂(Ru)₂ₓM₂₋₂ₓO₇, RE₂(Ir)₂ₓM₂₋₂ₓO₇ or RE₂(Ir,Ru)₂ₓM₂₋₂ₓO₇, where RE is a rare earth element, M is an alkali metal, alkaline earth metal, transition metal, post-transition metal, Ge, or Sb, and x is less than 1.0 and greater than 0.0.

In another form of the present disclosure, an electrocatalyst for catalyzing the OER includes a pyrochlore compound with a composition or chemical formula of RE₂(Ru)₂ₓM₂₋₂ₓO₇, RE₂(Ir)₂ₓM₂₋₂ₓO₇ or RE₂(Ir,Ru)₂ₓM₂₋₂ₓO₇, where x is less than or equal to 0.95 and greater than or equal to 0.0, RE is a rare earth element and M is at least one of an alkali metal, alkaline earth metal, transition metal, post-transition metal, Ge, or Sb selected, respectively, from Dy and Al, Dy and Mn, Er and Mn, Er and Sc, Eu and Zr, Ho and Bi, Ho and Sc, Ho and Sn, Nd and Ta, Pr and Ge, Y and Mo, Y and Sn, Y and Ti, Y and Re, or Y and Sb.

In still another form of the present disclosure, an electrocatalyst for the production of hydrogen from water includes a pyrochlore compound with a composition of chemical formula RE₂(Ru)₂ₓM₂₋₂ₓO₇, RE₂(Ir)₂ₓM₂₋₂ₓO₇ or RE₂(Ir,Ru)₂ₓM₂₋₂ₓO₇, where x is less than or equal to 0.9 and greater than or equal 0.0, and RE is a rare earth element and M is at least one of an alkali metal, alkaline earth metal, transition metal, post-transition metal, Ge, or Sb selected, respectively, from Ho and Al, Ho and Ga, Nd and Al, Nd and Cr, Nd and Hf, Nd and K, Nd and Mo, Nd and Sc, Nd and Ti, Nd and Zr, Sm and Mn, Sm and Sc, SM and Sn, Sm and Zr Tb and Zr, Y and Fe, Y and Ga, Y and Ge, Y and Hf, Y and Mn, Yb and Hf, Yb and Mo, or Yb and Ti.

These and other features of the electrocatalyst will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 shows a water electrolysis cell according to the teachings of the present disclosure;

FIG. 2A shows a crystal structure for a RE₂(Ru)₂ₓM₂₋₂ₓO₇, RE₂(Ir)₂ₓM₂₋₂ₓO₇ or RE₂(Ir,Ru)₂ₓM₂₋₂ₓO₇ pyrochlore compound (labeled simply as “RE₂(Ir,Ru)₂ₓM₂₋₂ₓO₇”) shown as with x=0.0 according to the teachings of the present disclosure;

FIG. 2B shows a crystal structure for a RE₂(Ru)₂ₓM₂₋₂ₓO₇, RE₂(Ir)₂ₓM₂₋₂ₓO₇ or RE₂(Ir,Ru)₂ₓM₂₋₂ₓO₇ pyrochlore compound (labeled simply as “RE₂(Ir,Ru)₂ₓM₂₋₂ₓO₇”) with x=0.25 according to the teachings of the present disclosure;

FIG. 2C shows a crystal structure for a RE₂(Ru)₂ₓM₂₋₂ₓO₇, RE₂(Ir)₂ₓM₂₋₂ₓO₇ or RE₂(Ir,Ru)₂ₓM₂₋₂ₓO₇ pyrochlore compound (labeled simply as “RE₂(Ir,Ru)₂ₓM₂₋₂ₓO₇”) with x=0.583 according to the teachings of the present disclosure;

FIG. 2D shows a crystal structure for a RE₂(Ru)₂ₓM₂₋₂ₓO₇, RE₂(Ir)₂ₓM₂₋₂ₓO₇ or RE₂(Ir,Ru)₂ₓM₂₋₂ₓO₇ pyrochlore compound (labeled simply as “RE₂(Ir,Ru)₂ₓM₂₋₂ₓO₇”) with x=0.75 according to the teachings of the present disclosure;

FIG. 2E shows a crystal structure for a RE₂(Ru)₂ₓM₂₋₂ₓO₇, RE₂(Ir)₂ₓM₂₋₂ₓO₇ or RE₂(Ir,Ru)₂ₓM₂₋₂ₓO₇ pyrochlore compound (labeled simply as “RE₂(Ir,Ru)₂ₓM₂₋₂ₓO₇”) with x=0.833 according to the teachings of the present disclosure; and

FIG. 3 shows a filtering system for screening possible pyrochlore compounds for synthesis and use.

It should be noted that the figures set forth herein is intended to exemplify the general characteristics of the methods, algorithms, and devices among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

The present disclosure provides electrocatalysts for the production of hydrogen from water, and particularly, electrocatalysts for catalyzing the OER in acidic conditions during the production of hydrogen gas (H₂ gas) from water (H₂O liquid). In some variations, an electrocatalyst according to the teachings of the present disclosure is a pyrochlore compound containing a rare earth (RE) element, ruthenium (Ru) and/or iridium (Ir), and an alkali metal, alkaline earth metal, transition metal, post-transition metal, Ge, or Sb. As used herein, alkali metals refers to lithium (Li), sodium (Na), potassium (K), rubidium (Rb), cesium (Cs), and, alkaline earth metals refer to beryllium (Be), magnesium (Mg), calcium (Ca), strontium (Sr), barium (Ba), and, transition metals refer to scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg), and post-transition metals refer to aluminum (Al), gallium (Ga), indium (In), tin (Sn), thallium (Tl), lead (Pb), and bismuth (Bi).

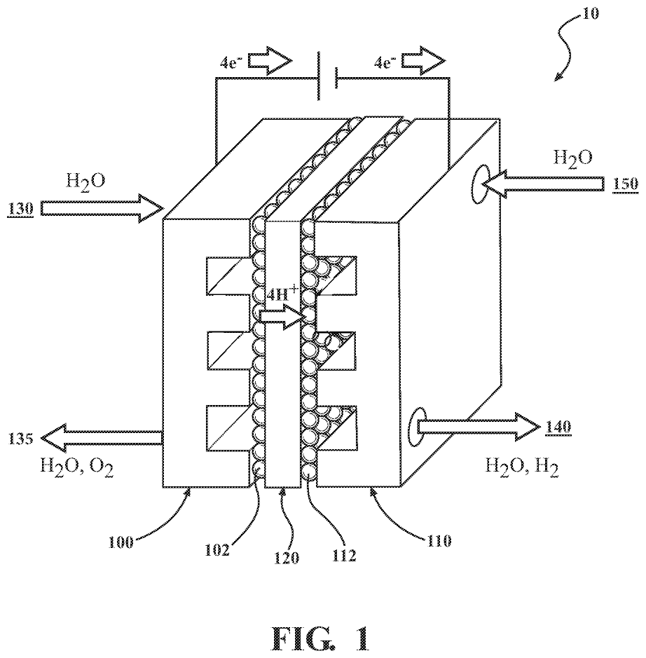

Referring to FIG. 1, a water electrolysis cell 10 for the production of hydrogen is shown. The cell includes an anode 100, an OER electrocatalyst 102, a cathode 110, a hydrogen evolution reaction electrocatalyst 112, an electrolyte 120, a water intake 130 and a water outlet 135 in fluid communication with the anode 100, and a hydrogen outlet 140 in fluid communication with the cathode 110 that receives water from a water intake 150. In some variations, the electrolyte 120 is polymer electrolyte membrane (PEM) and the water electrolysis cell 10 is a PEM electrolyzer.

In operation, electricity is provided via an external circuit (not shown) across the anode 100 and cathode 110 and water is fed or provided to the anode 100 via the water intake 130. The water is catalyzed by the OER electrocatalyst 102 into molecular oxygen and protons (positively charged hydrogen ions) per the OER:

$$2 {H}_{2} O \text{=>} {O}_{2} + 4 {H}^{+} + 4 {e}^{-} .$$

And the electrons from the OER flow through the external circuit, the hydrogen ions selectively move/migrate across the electrolyte 120 to the cathode 110, and the hydrogen ions combine with the electrons at the cathode 110 to form hydrogen per the reaction:

$$4 {H}^{+} + 4 {e}^{-} \text{=>} 2 {H}_{2} .$$

In some variations, acid is added to the water to increase ionization thereof such that the acidic water conducts electricity. However, the OER in acid conditions is relatively slow (sluggish), and to date, the OER electrocatalyst 102 relies on cost prohibitive (expensive) Ir-and Ru-based materials. Accordingly, any replacement of the Ir and/or Ru in the OER electrocatalyst 102 with less expensive elements is advantageous for green hydrogen production, i.e., the production of hydrogen via the electrolysis of water.

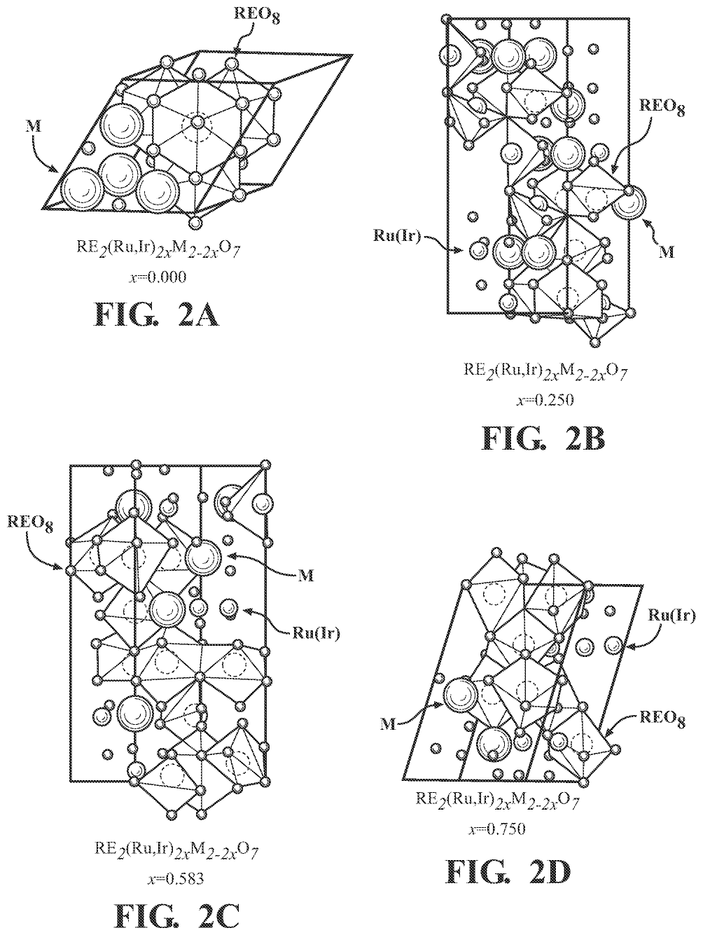

The OER electrocatalyst 102 according to the teachings of the present disclosure includes a pyrochlore compound with the composition or chemical formula RE₂(Ru)₂ₓM₂₋₂ₓO₇, RE₂(Ir)₂ₓM₂₋₂ₓO₇ or RE₂(Ir,Ru)₂ₓM₂₋₂ₓO₇ where RE is a rare earth element and M is an alkali metal, alkaline earth metal, transition metal, post-transition metal, Ge, or Sb substituting for at least a portion of the Ru and/or Ir. For example, and with reference to FIGS. 2A-2E, crystal structures for the pyrochlore compound RE₂(Ru)₂ₓM₂₋₂ₓO₇, RE₂(Ir)₂ₓM₂₋₂ₓO₇ or RE₂(Ir,Ru)₂ₓM₂₋₂ₓO₇ with x=0.000 (FIG. 2A), x=0.250 (FIG. 2B), x=0.583 (FIG. 2C), x=0.750 (FIG. 2D), and x=0.833 (FIG. 2E) are shown. In some variations, x is less than 1.0, e.g., less than or equal to 0.95 or less than or equal 0.90. And in at least one variation, x is less than or equal to 0.85.

It should be understood that pyrochlore compounds RE₂(Ru)₂ₓM₂₋₂ₓO₇, RE₂(Ir)₂ₓM₂₋₂ₓO₇ or RE₂(Ir,Ru)₂ₓM₂₋₂ₓO₇ according to the teachings of the present disclosure are pyrochlore compounds doped with M and are not pyrochlore compounds with incidental impurities in the parts per million (ppm) or parts per billion (ppb) range.

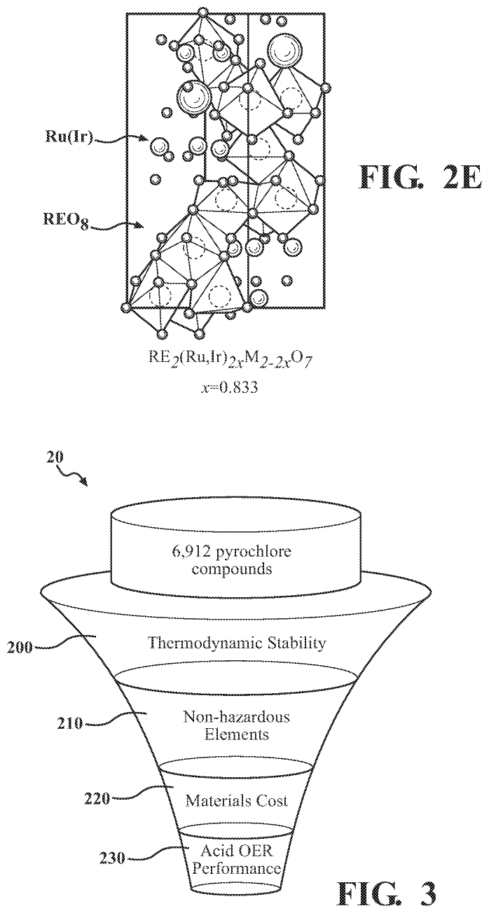

Not being bound by theory, pyrochlore compounds having the chemical formula RE₂(Ru)₂ₓM₂₋₂ₓO₇, RE₂(Ir)₂ₓM₂₋₂ₓO₇ or RE₂(Ir,Ru)₂ₓM₂₋₂ₓO₇ where RE is a rare carth element and M is an alkali metal, alkaline carth metal, transition metal, post-transition metal, Ge, or Sb results in a total of 6,912 possible pyrochlore compounds. Accordingly, and with reference to FIG. 3, a filtering system 20 for screening and providing a reduced set of pyrochlore compounds for synthesis and use is shown and described below.

The filtering system 20 includes a first filter in the form of a thermodynamic stability filter 200 that screens possible pyrochlore compounds via one or more thermodynamic stability criteria. Particularly, the 6,912 possible pyrochlore compounds were screened using transfer learning predictions of the decomposition energy, ΔH_{d}, as described in the publication titled “Transfer learning aided high-throughput computational design of oxygen evolution reaction catalysts in acid conditions”. Wang et al., Journal of Energy Chemistry 80 (2023) 744-757 (hereafter “Wang et al.”), which is incorporate herein in its entirety by reference. The ΔH_{d} is a measure of the thermodynamic driving force to decompose a compound into its most stable format (structure) and this provides a measure of the thermodynamic stability, and synthesis, of a given pyrochlore compound. Stated differently, comparing the transfer learning predictions of the 6,912 possible pyrochlore allows for the least or lesser thermodynamically stable pyrochlore compounds to be removed from further consideration with respect to synthesis and use for catalyzing the OER.

Using the transfer learning predictions of the decomposition energy as taught in Wang et al. for the 6,912 possible pyrochlore compounds provided a ΔH_{d} between about −50 meV/atom and about +80 meV/atom for a majority thereof. And while it should be understood that a negative value for ΔH_{d} for a pyrochlore compound corresponds to a true ground state and a higher positive value indicates less thermodynamic stability, it should also be understood that ΔH_{d} does not serve as or is not a direct indicator for synthesis feasibility for a given compound. In fact, there is typically no quantitative criterion that determines or separates whether a compound can be synthesized. Stated differently, decomposition energy was used as an indicator for synthesizability with a negative decomposition energy indicating a compound having higher probability of being synthesized and more positive values indicating a compound having a lower probability of being synthesized. Accordingly, using decomposition energy as a criteria for synthesizability is not an absolute rule but worked well in the high-throughput screening process disclosed herein. And as a first approximation, a ΔH_{d} equal to +26 meV/atom or less was used as the thermodynamic stability filter for downsizing the 6,912 potential pyrochlore compounds for further study, i.e., compounds with a ΔH_{d} greater than +26 meV/atom were screened (removed) from further consideration, which in turn left a total of 2,617 possible pyrochlore compounds for further consideration.

Still referring to FIG. 3, a second filter in the form of a non-hazardous elements filter 210 was used for toxicity and radioactivity screening of the RE, alkali metal, alkaline earth metal, transition metal, post-transition metal, Ge, or Sb that could be present in the 2,617 possible RE₂(Ru)₂ₓM₂₋₂ₓO₇, RE₂(Ir)₂ₓM₂₋₂ₓO₇ or RE₂(Ir,Ru)₂ₓM₂₋₂ₓO₇ pyrochlore compounds resulting from or passing through the thermodynamic stability filter 200. That is, RE₂(Ru)₂ₓM₂₋₂ₓO₇, RE₂(Ir)₂ₓM₂₋₂ₓO₇ or RE₂(Ir, Ru)₂ₓM₂₋₂ₓO₇ pyrochlore compounds that included elements that are known for their toxicity and/or radioactively (e.g., Tc, Pm, Be, Cd, Hg, Tl, and Pb) were screened (removed) from further consideration, which in turn left a total of 2,103 possible pyrochlore compounds for further consideration.

A third filter in the form of a materials cost filter 220 was used for materials cost screening, e.g., precious metals, which could be present in the 2,103 possible RE₂(Ru)₂ₓM₂₋₂ₓO₇, RE₂(Ir)₂ₓM₂₋₂ₓO₇ or RE₂(Ir,Ru)₂ₓM₂₋₂ₓO₇ pyrochlore compounds resulting from or passing through the thermodynamic stability filter 200 and the non-hazardous clements filter 210. Particularly, RE₂(Ru)₂ₓM₂₋₂ₓO₇, RE₂(Ir)₂ₓM₂₋₂ₓO₇, and RE₂(Ir,Ru)₂ₓM₂₋₂ₓO₇ pyrochlore compounds that included elements Ir, Rh, Pd, Os, Pt, Ag, and Au were screened (removed) from consideration, which in turn left a total of 480 possible RE₂(Ru)₂ₓM₂₋₂ₓO₇ pyrochlore compounds for further consideration.

A fourth filter in the form of an acid OER performance filter 230 was used for screening the 480 possible pyrochlore compounds for further consideration resulting from or passing through the thermodynamic stability filter 200, non-hazardous elements filter 210, and material cost filter 220. And while the catalytic activity of a catalyst has typically required time and cost intensive approaches to acquire detailed knowledge of a catalyst's surface properties as well as the mechanism of catalytic process, the catalytic activity of the pyrochlore compounds according to the teachings of the present disclosure was investigated using the calculated oxygen 2p-band center (ε₂ₚ) for each compound as a general descriptor for the OER activity as described in Wang et al. and defined as:

$${ε}_{2 p} = \frac{{\int }_{{E}_{min}}^{{E}_{max}} E {ρ}_{2 p} dE}{{\int }_{{E}_{min}}^{{E}_{max}} {ρ}_{2 p} dE} \qquad Eq . 1$$

where E represent energy levels, Eₘᵢₙ is lower energy bound used to calculate ε₂ₚ, Eₘₐₓ is the upper energy bound used to calculate ε₂ₚ, and ρ₂ₚ is the projected density of states on oxygen (O) 2p states.

The acid OER performance filter 230 resulted in a total of 59 pyrochlore compounds predicted to exhibit desired acid OER catalytic activity with Ru at least partially replaced with M. The 59 pyrochlore compounds are shown in Table 1 below, along with the ΔH_{d} and ε₂ₚ for each pyrochlore compound. And as observed in Table 1, the 59 pyrochlore compounds fell into three groups or sets, with the first group (I) being RE₂(Ru)₂ₓM₂₋₂ₓO₇ pyrochlore compounds with a calculated ε₂ₚ between −0.94 eV and −0.90 eV, the second group (II) being RE₂(Ru)₂ₓM₂₋₂ₓO₇ pyrochlore compounds with a calculated ε₂ₚ between −0.86 eV and −0.82 eV, and the third group (III) being RE₂(Ru)₂ₓM₂₋₂ₓO₇ pyrochlore compounds with a calculated ε₂ₚ between −0.77 eV and −0.73 eV.

TABLE 1

| Formula | RE—M | ΔH_{d} | ε₂ₚ | Set |
|---|---|---|---|---|
| Dy₂(Ru)_{1.5}Al_{0.5}O₇ | Dy—Al | 16 | −0.93 | I |
| Dy₂(Ru)_{1.2}Mn_{0.8}O₇ | Dy—Mn | 26 | −0.90 | I |
| Er₂(Ru)_{1.7}Mn_{0.3}O₇ | Er—Mn | 23 | −0.90 | I |
| Er₂(Ru)_{1.7}Sc_{0.3}O₇ | Er—Sc | 25 | −0.92 | I |
| Eu₂(Ru)_{0.5}Zr_{1.5}O₇ | Eu—Zr | 15 | −0.93 | I |
| Ho₂(Ru)_{1.7}Bi_{0.3}O₇ | Ho—Bi | 26 | −0.92 | I |
| Ho₂(Ru)_{1.7}Sc_{0.3}O₇ | Ho—Sc | 22 | −0.92 | I |
| Ho₂(Ru)_{1.5}Sn_{0.5}O₇ | Ho—Sn | 22 | −0.02 | I |
| Nd₂(Ru)_{1.7}Ta_{0.3}O₇ | Nd—Ta | 25 | −0.94 | I |
| Pr₂(Ru)_{1.2}Ge_{0.8}O₇ | Pr—Ge | 22 | −0.93 | I |
| Y₂(Ru)_{1.7}Mo_{0.3}O₇ | Y—Mo | 21 | −0.92 | I |
| Y₂(Ru)_{1.5}Sn_{0.5}O₇ | Y—Sn | 22 | −0.93 | I |
| Y₂(Ru)_{1.7}Ti_{0.3}O₇ | Y—Ti | 26 | −0.92 | I |
| Yb₂(Ru)_{1.7}Re_{0.3}O₇ | Y—Re | −19 | −0.91 | I |
| Yb₂(Ru)_{1.5}Sb_{0.5}O₇ | Y—Sb | −72 | −0.90 | I |
| Dy₂(Ru)_{1.5}Cu_{0.5}O₇ | Dy—Cu | 18 | −0.86 | II |
| Er₂(Ru)_{1.7}Al_{0.3}O₇ | Er—Al | 21 | −0.87 | II |
| Eu₂(Ru)_{1.7}Fe_{0.3}O₇ | Eu—Fe | 21 | −0.86 | II |
| Eu₂(Ru)_{0.5}Hf_{1.5}O₇ | Eu—Hf | 24 | −0.85 | II |
| Eu₂(Ru)_{1.7}Mn_{0.3}O₇ | Eu—Mn | 25 | −0.87 | II |
| Ho₂(Ru)_{1.7}Al_{0.3}O₇ | Ho—Al | 20 | −0.86 | II |
| Ho₂(Ru)_{1.7}Cr_{0.3}O₇ | Ho—Cr | 15 | −0.85 | II |
| Ho₂(Ru)_{1.7}Ga_{0.3}O₇ | Ho—Ga | 21 | −0.87 | II |
| Nd₂(Ru)_{1.5}Sn_{0.5}O₇ | Nd—Sn | 14 | −0.853 | II |
| Nd₂(Ru)_{1.7}Sn_{0.3}O₇ | Nd—Sn | 7 | −0.835 | II |
| Sm₂(Ru)_{1.7}Bi_{0.3}O₇ | Sm—Bi | 9 | −0.863 | II |
| Sm₂(Ru)_{1.7}Ga_{0.3}O₇ | Sm—Ga | 2 | −0.863 | II |
| Sm₂(Ru)_{1.7}Ge_{0.3}O₇ | Sm—Ge | 8 | −0.848 | II |
| Sm₂(Ru)_{1.7}Mo_{0.3}O₇ | Sm—Mo | 16 | −0.86 | II |
| Sm₂(Ru)_{1.7}Ti_{0.3}O₇ | Sm—Ti | 19 | −0.83 | II |
| Y₂(Ru)_{1.7}Cr_{0.3}O₇ | Y—Cr | 3 | −0.84 | II |
| Y₂(Ru)_{1.7}K_{0.3}O₇ | Y—K | 19 | −0.85 | II |
| Y₂(Ru)_{1.7}Sn_{0.3}O₇ | Y—Sn | 20 | −0.84 | II |
| Yb₂(Ru)_{1.7}Ta_{0.3}O₇ | Yb—Ta | −59 | −0.83 | II |
| Er₂(Ru)_{1.5}A_{10.5}O₇ | Er—Al | 25 | −0.76 | III |
| Ho₂(Ru)_{1.5}A_{10.5}O₇ | Ho—Al | 24 | −0.75 | III |
| Ho₂(Ru)_{1.5}Ga_{0.5}O₇ | Ho—Ga | 25 | −0.77 | III |
| Nd₂(Ru)_{1.7}A_{10.3}O₇ | Nd—Al | 14 | −0.76 | III |
| Nd₂(Ru)_{1.7}Cr_{0.3}O₇ | Nd—Cr | 4 | −0.75 | III |
| Nd₂(Ru)_{1.7}Hf_{0.3}O₇ | Nd—Hf | 8 | −0.74 | III |
| Nd₂(Ru)_{1.7}K_{0.3}O₇ | Nd—K | 15 | −0.76 | III |
| Nd₂(Ru)_{1.7}Mo_{0.3}O₇ | Nd—Mo | 18 | −0.74 | III |
| Nd₂(Ru)_{1.7}Sc_{0.3}O₇ | Nd—Sc | −5 | −0.76 | III |
| Nd₂(Ru)_{1.7}Ti_{0.3}O₇ | Nd—Ti | 22 | −0.74 | III |
| Nd₂(Ru)_{1.7}Zr_{0.3}O₇ | Nd—Zr | 8 | −0.74 | III |
| Sm₂(Ru)_{1.7}Mn_{0.3}O₇ | Sm—Mn | 7 | −0.75 | III |
| Sm₂(Ru)_{1.7}Sc_{0.3}O₇ | Sm—Sc | −7 | −0.75 | III |
| Sm₂(Ru)_{1.5}Sn_{0.5}O₇ | Sm—Sn | 11 | −0.74 | III |
| Sm₂(Ru)_{1.5}Zr_{0.5}O₇ | Sm—Zr | 10 | −0.76 | III |
| Tb₂(Ru)_{1.7}Zr_{0.3}O₇ | Tb—Zr | 21 | −0.75 | III |
| Y₂(Ru)_{1.5}Fe_{0.5}O₇ | Y—Fe | −11 | −0.75 | III |
| Y₂(Ru)_{1.7}Ga_{0.3}O₇ | Y—Ga | 5 | −0.75 | III |
| Y₂(Ru)_{1.7}Ge_{0.3}O₇ | Y—Ge | 22 | −0.76 | III |
| Y₂(Ru)_{1.2}Hf_{0.8}O₇ | Y—Hf | 24 | −0.75 | III |
| Y₂(Ru)_{1.2}Mn_{0.8}O₇ | Y—Mn | 0 | −0.77 | III |
| Yb₂(Ru)_{1.2}Hf_{0.8}O₇ | Yb—Hf | −18 | −0.74 | III |
| Yb₂(Ru)_{1.5}Mo_{0.5}O₇ | Yb—Mo | −13 | −0.74 | III |
| Yb₂(Ru)_{1.5}Ti_{0.5}O₇ | Yb—Ti | 1 | −0.76 | III |
| Yb₂(Ru)_{1.7}Ti_{0.3}O₇ | Yb—Ti | −11 | −0.75 | III |

Still referring to Table 1, among all rare earth elements, eleven (11) Y- and Nd-containing compounds were predicted, nine (9) Sm-containing compounds, eight (8) Ho-containing compounds, and eight (8) Yb-containing compounds. However, pyrochlore compounds with the rare earth elements La, Ce, Pr, Pm, Gd, and Lu were not predicted and thus are not recommended as OER electrocatalysts. And regarding the metal dopant atoms, 4d- and 5d-transition metal dopants were present 8 and 7 times, respectively, thereby indicating such dopant elements are generally not recommended. The least frequent dopants were alkali and alkali earth elements with only two K-doped compositions shown in Table 1. In contrast, 3d-transition metal dopant elements and p-block dopant elements were 20 and 21 times, respectively, and among the p-block dopant elements, aluminum and tin are of particular interest in the screening due to their costs. And while the 59 predicted pyrochlore compounds did not include Ir. i.e., pyrochlore compounds containing Ir were filtered out by the materials cost filter 220, it should be understood that Ir containing pyrochlore compounds (i.e., RE₂(Ir)₂ₓM₂₋₂ₓO₇ and RE₂(Ir,Ru)₂ₓM₂₋₂ₓO₇ pyrochlore compounds) are included in the teachings of the present disclosure unless expressly stated to not be present and such Ir containing pyrochlore compounds would be expected and/or do perform similar to the RE₂(Ru)₂ₓM₂₋₂ₓO₇ compounds discussed above.

Accordingly, and in view of the above, the RE₂(Ru)₂ₓM₂₋₂ₓO₇, RE₂(Ir)₂ₓM₂₋₂ₓO₇, and RE₂(Ir,Ru)₂ₓM₂₋₂ₓO₇ pyrochlore compounds according to the teachings of the present disclosure have a calculated oxygen 2p-band center (ε₂ₚ) between about −0.940 electron volts (eV) and about −0.730 eV relative to Fermi level, where the phrase “Fermi level” as used herein is defined as the highest energy level an electron can occupy at absolute zero temperature.

Also, the RE element can include one or more of dysprosium (Dy), erbium (Er), curopium (Eu), holmium (Ho), neodymium (Nd), prascodymium (Pr), samarium (Sm), terbium (Tb), yttrium (Y), and ytterbium (Yb). Also, M of the OER electrocatalyst 102 can be an alkali metal, alkaline earth metal, transition metal, post-transition metal, Ge, or Sb, such as one or more of aluminum (Al), bismuth (Bi), chromium (Cr), copper (Cu), iron (Fc), gallium (Ga), germanium (Ge), hafnium (Hf), potassium (K), manganese (Mn), molybdenum (Mo), rhenium (Re), antimony (Sb), scandium (Sc), tin (Sn), tantalum (Ta), titanium (Ti), and zirconium (Zr).

In some variations, the value of x in the RE₂(Ru)₂ₓM₂₋₂ₓO₇, RE₂(Ir)₂ₓM₂₋₂ₓO₇ and RE₂(Ir,Ru)₂ₓM₂₋₂ₓO₇ pyrochlore compounds is less than 1.0 and greater than 0.0, e.g., less than or equal to 0.95 and greater than 0.0, less than or equal to 0.90 and greater than or equal to 0.10, less than or equal to 0.85 and greater than or equal to 0.15, less than or equal to 0.75 and greater than or equal to 0.20, less than or equal to 0.60 and greater than or equal to 0.20, or less than or equal to 0.50 and greater than or equal to 0.20.

In at least one variation, the electrocatalyst has the composition of RE₂(Ru)₂ₓM₂₋₂ₓO₇, RE₂(Ir)₂ₓM₂₋₂ₓO₇ or RE₂(Ir,Ru)₂ₓM₂₋₂ₓO₇ where x is less than or equal to 0.85 and greater than 0.0 as noted above, and RE and M are selected, respectively, from the pair of elements Dy and Al, Dy and Mn, Er and Mn, Er and Sc, Eu and Zr, Ho and Bi, Ho and Sc, Ho and Sn, Nd and Ta, Pr and Ge, Y and Mo, Y and Sn, Y and Ti, Y and Re, or Y and Sb. And in such variations, the pyrochlore compound can have a calculated oxygen 2p-band center ε₂ₚ between about −0.940 eV and about −0.900 eV relative to Fermi level.

In other variations, the electrocatalyst is a pyrochlore compound with a composition of RE₂(Ru)₂ₓM₂₋₂ₓO₇, RE₂(Ir)₂ₓM₂₋₂ₓO₇ or RE₂(Ir,Ru)₂ₓM₂₋₂ₓO₇ where x is less than or equal to 0.85 and greater than 0.0 as noted above, and RE and M are selected, respectively, from the pair of elements Dy and Cu, Er and Al, Eu and Fe, Eu and Hf, Eu and Mn, Ho and Al, Ho and Cr, Ho and Ga, Nd and Sn, Sm and Bi, Sm and Ga, Sm and Ge, Sm and Mo, Sm and Ti, Y and Cr, Y and K, Y and Sn, or Yb and Ta. And in such variations, the pyrochlore compound can have a calculated oxygen 2p-band center ε₂ₚ between about −0.860 eV and about −0.820 eV relative to Fermi level.

In some variations, the electrocatalyst is a pyrochlore compound with composition of RE₂(Ru)₂ₓM₂₋₂ₓO₇, RE₂(Ir)₂ₓM₂₋₂ₓO₇ or RE₂(Ir,Ru)₂ₓM₂₋₂ₓO₇ where x is less than or equal to 0.85 and greater than 0.0 as noted above, and RE and M are selected, respectively, from the pair of elements Er and Al, Ho and Al, Ho and Ga, Nd and Al, Nd and Cr, Nd and Hf, Nd and K, Nd and Mo, Nd and Sc, Nd and Ti, Nd and Zr, Sm and Mn, Sm and Sc, SM and Sn, Sm and Zr, Tb and Zr, Y and Fe, Y and Ga, Y and Ge, Y and Hf, Y and Mn, Yb and Hf, Yb and Mo, or Yb and Ti. And in such variations, the pyrochlore compound can have a calculated oxygen 2p-band center ε₂ₚ between about −0.770 eV and about −0.730 eV relative to Fermi level.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should also be understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An electrocatalyst comprising:
a pyrochlore compound selected from RE₂(Ru)₂ₓM₂₋₂ₓO₇, RE₂(Ir)₂ₓM₂₋₂ₓO7 or RE₂(Ir,Ru)₂ₓM₂₋₂ₓO₇, where RE is a rare earth element, M is an alkali metal, alkaline earth metal, transition metal, post-transition metal, Ge, or Sb, and x is less than 1.0 and greater than 0.0.

2. The electrocatalyst according to claim 1, wherein RE is selected from the group consisting of Dy, Er, Eu, Ho, Nd, Pr, Sm, Tb, Y, and Yb.

3. The electrocatalyst according to claim 2, wherein M is selected from the group consisting of Sc, Ti, V, Cr, Mn, Fe, Co, Ni, Cu, Zn, Al, Ga, In, Sn, Tl, Pb, Bi, Ge, Zr, Ta, Hf, Mo, Re, K, Sb, Nb, Li.

4. The electrocatalyst according to claim 3, wherein the pyrochlore compound comprises a calculated oxygen 2p-band center (ε₂ₚ) between about −0.940 eV and about −0.730 eV relative to Fermi level.

5. The electrocatalyst according to claim 1, wherein RE and M are selected, respectively, from the group consisting of Dy and Al, Dy and Mn, Er and Mn, Er and Sc, Eu and Zr, Ho and Bi, Ho and Sc, Ho and Sn, Nd and Ta, Pr and Ge, Y and Mo, Y and Sn, Y and Ti, Y and Re, and Y and Sb.

6. The electrocatalyst according to claim 5, wherein the pyrochlore compound comprises a calculated oxygen 2p-band center (ε₂ₚ) between about −0.940 eV and about −0.900 eV relative to Fermi level.

7. The electrocatalyst according to claim 1, wherein RE and M are selected, respectively, from the group consisting of Dy and Cu, Er and Al, Eu and Fe, Eu and Hf, Eu and Mn, Ho and Al, Ho and Cr, Ho and Ga, Nd and Sn, Sm and Bi, Sm and Ga, Sm and Ge, Sm and Mo, Sm and Ti, Y and Cr, Y and K, Y and Sn, and Yb and Ta.

8. The electrocatalyst according to claim 7, wherein the pyrochlore compound comprises a calculated oxygen 2p-band center (ε₂ₚ) between about −0.860 eV and about −0.820 eV relative to Fermi level.

9. The electrocatalyst according to claim 1, wherein RE and M are selected, respectively, from the group consisting of Er and Al, Ho and Al, Ho and Ga, Nd and Al, Nd and Cr, Nd and Hf, Nd and K, Nd and Mo, Nd and Sc, Nd and Ti, Nd and Zr, Sm and Mn, Sm and Sc, SM and Sn, Sm and Zr Tb and Zr, Y and Fe, Y and Ga, Y and Ge, Y and Hf, Y and Mn, Yb and Hf, Yb and Mo, and Yb and Ti.

10. The electrocatalyst according to claim 9, wherein the pyrochlore compound comprises a calculated oxygen 2p-band center (ε₂ₚ) between about −0.770 eV and about −0.730 eV relative to Fermi level.

11. The electrocatalyst according to claim 1, wherein x is less than or equal to 0.95 and greater than or equal 0.10.

12. The electrocatalyst according to claim 1, wherein x is less than or equal to 0.85 and greater than or equal 0.10.

13. The electrocatalyst according to claim 1, wherein x is less than or equal to 0.6 and greater than or equal 0.20.

14. An electrocatalyst comprising:
a pyrochlore compound selected from RE₂(Ru)₂ₓM₂₋₂ₓO₇, RE₂(Ir)₂ₓM₂₋₂ₓO7 or RE₂(Ir,Ru)₂ₓM₂₋₂ₓO₇, where x is less than or equal to 0.95 and greater than or equal 0.0, and RE is a rare earth element and M is at least one of an alkali metal, alkaline earth metal, transition metal, post-transition metal, Ge, or Sb selected, respectively, from the group consisting of Dy and Al, Dy and Mn, Er and Mn, Er and Sc, Eu and Zr, Ho and Bi, Ho and Sc, Ho and Sn, Nd and Ta, Pr and Ge, Y and Mo, Y and Sn, Y and Ti, Y and Re, and Y and Sb.

15. The electrocatalyst according to claim 14, wherein the pyrochlore compound comprises a calculated oxygen 2p-band center (ε₂ₚ) between about −0.940 eV and about −0.900 eV relative to Fermi level.

16. The electrocatalyst according to claim 15, wherein x is less than or equal to 0.80 and greater than or equal 0.2.

17. The electrocatalyst according to claim 16, wherein x is less than or equal to 0.60 and greater than or equal 0.2.

18. An electrocatalyst comprising:
A pyrochlore compound selected from RE₂(Ru)₂ₓM₂₋₂ₓO₇, RE₂(Ir)₂ₓM₂₋₂ₓO₇ or RE₂(Ir,Ru)₂ₓM₂₋₂ₓO₇, where x is less than or equal to 0.9 and greater than or equal 0.0, and RE is a rare earth element and M is at least one of an alkali metal, alkaline earth metal, transition metal, post-transition metal, Ge, or Sb selected, respectively, from the group consisting of Ho and Al, Ho and Ga, Nd and Al, Nd and Cr, Nd and Hf, Nd and K, Nd and Mo, Nd and Sc, Nd and Ti, Nd and Zr, Sm and Mn, Sm and Sc, SM and Sn, Sm and Zr Tb and Zr, Y and Fe, Y and Ga, Y and Ge, Y and Hf, Y and Mn, Yb and Hf, Yb and Mo, and Yb and Ti.

19. The electrocatalyst according to claim 18, wherein the pyrochlore compound comprises a calculated oxygen 2p-band center (ε₂ₚ) between about −0.860 eV and about −0.820 eV relative to Fermi level.

20. The electrocatalyst according to claim 19, wherein x is less than or equal to 0.60 and greater than or equal 0.2.
